(19) United States
(12) Patent Application Publication
(10) Pub. No.: US 2003/0178744 A1
(43) Pub. Date: Sep. 25, 2003

(54) Multicolour and multiple material injection moulding of a capsule provided with a cap pivoting about a hinge

(76) Inventor: Bernard Schneider, Sainte Menehould (FR)

Correspondence Address: Paul D Greeley, Ohlandt Greeley Ruggiero & Perle, 10th Floor, One Landmark Square, Stamford, CT, 06901-2682, US

(21) Appl. No.: 10/257,522

(22) PCT Filed: Apr. 10, 2001
(86) PCT No.: PCT/FR01/01084

(51) Int. Cl. B29C 45/00

(52) U.S. Cl. 264/255; 264/328.7; 264/328.8

(57) ABSTRACT

The invention concerns a method for sequential moulding with multiple materials for making a piece comprising at least two parts with matching shapes produced in a different plastic material, mobile relative to each other by pivoting about a hinge, which consists in: using a moulding equipment comprising a second mould (30) and a first mould (31) whereof the assembled impressions define the cavity of the open part, the mobile portions forming between them an angle of about 180°, one of the moulds (31) comprising a housing wherein slides a gate (35), capable of blocking the flow of the first plastic material; injecting the first portion (32, 34) with a first plastic material, the gate (35) providing with its side wall an obstacle to the flow of said first plastic material at the fasteners of the elements of the hinge on the second piece; causing the gate (35) to open and injecting the second plastic material into the second portion (33) of the piece.

### TECHNICAL FIELD

The invention relates to a moulding process for capsules that will be fixed on containers such as flexible tubes, bottles or tottles. The said capsules are provided with a pivoting cap that closes a distribution orifice. This type of container will be used to store and distribute fluid, cream or paste materials generally used for cosmetics, food, household, pharmaceutical or parapharmaceutical. We will use the general term “tubes” throughout the rest of this description to denote all of these containers.

### STATE OF THE ART

With capsules fitted with a pivoting cap, the consumer can manipulate the tube with a single hand and be sure he or she will not lose the lid, since it is very easy to put the lid down and accidentally lose it after detaching it to release the distribution orifice. This type of capsule became much more widely used when it became possible to mould them in a single part, with the consequence of significantly reducing their manufacturing cost.

Capsules made in this way comprise a base and a pivoting cap attached to this base. The base comprises a top plate provided with a distribution orifice, an outer skirt that is usually located along the extension of the flexible skirt of the tube when the capsule is fixed to the tube, and attachment elements that will cooperate with corresponding means arranged on the head of the flexible tube. The cap is attached to the base, usually on the top plate of the said base, and frequently at the periphery through a hinge. This hinge usually includes at least one film-hinge stressed in bending, and at least one tensioning element stressed in tension. The tensioning element is put into tension when the cap pivots, and facilitates pivoting of the cap. All the user needs to do is to give a first push to trigger opening or closing.

These mechanical elements (hinge and tensioner) moulded from the same material as the base and the cap are subjected to frequent mechanical action. This requires the selection of a particular plastic material with suitable mechanical characteristics, particularly good resistance to fatigue due to the large number of times the tube is opened during use. In general, a material such as polypropylene is chosen, which not only has better resistance to fatigue but also is stiffer within the elastic range than the material from which the tube head is made, which is usually polyethylene.

However, the cap which is moulded simultaneously with the rest of the tube, is obviously made of the same material, which firstly limits the decorative possibilities of the capsule in that it is obliged to have the same monotonous, everyday and even inesthetic appearance, and also makes it more difficult to use the tube due to the rigid nature of the cap which is cold to touch and not very pleasant, and could even injure the user's thumb if the relief on the gripping projection of the cap is excessively pronounced.

Therefore, the applicant attempted to improve the appearance and usage comfort of the capsule by making the colour and/or the material of the cap different from the colour and/or material of the base. The applicant considered the bi-injection technique recently developed at capsule moulders. Patent applications FR 2 662 144 and EP 0 826 606 are typical of service capsules that can now be made using this type of process.

In FR 2 662 144, the cap, the outer part of the base and the elements of the hinge (film hinge and tensioning elements) are made of the same rigid polypropylene type material. Only the central part of the capsule base that comprises a sealing skirt is composed of another elastomer type material. The junction between the two materials is made at the periphery of the top plate of the base, in an area remote from the hinge at which mechanical stresses are fairly low.

In EP 0 826 606, the objective is to improve the marking and manipulation of the gripping area located partly on the cap and partly on the base of the capsule. The surface of the part of the base and the part of the cap specifically forming the said gripping area are covered by a layer of elastomeric material. In this type of configuration, the tensioning element connecting these two parts is also made entirely of this elastomeric material, while the other part of the cap, the other part of the base and the film hinge that connects them together are made of a rigid polypropylene type material.

In both cases, it is not a genuine service capsule composed of two different materials, one occupying the entire base and the other occupying the entire cap. If this objective has to be met, the boundary between the two materials has to be located at the junction between the film hinge(s) and the tensioning element(s), in other words at the zones of the capsule with the highest mechanical stresses. Therefore, there is a problem of mechanical strength, particularly in fatigue, of elements of the hinge located close to bonding between the materials.

Problem that Arises

The applicant tried to obtain a service capsule with a base made of a first plastic material and a cap made of a second plastic material, with a boundary between the plastic materials located at the hinge separating the base from the cap, without having any mechanical influence on the said hinge while the tube is being used.

### PURPOSE OF THE INVENTION

The purpose of the invention is a process for sequential multiple material injection moulding to make a part comprising at least two parts with matching shapes made of different plastic materials, free to move with respect to each other by pivoting about a hinge forming the junction between these two parts, the said hinge possibly being composed of several elements stressed in bending or tension, characterized in that:

a moulding tool comprising a first mould and a second mould is used, in which the impressions are such that once the first and second moulds are assembled and locked together, they define the cavity of the open part, the opening angle between the mobile parts being large, typically close to 1800, the first mould comprising a housing in which a mobile element called a gate is free to slide, with two side walls and a front wall that blocks the flow of the first plastic material when it is in the closed position, the said gate sliding in the cavity that will contain the second plastic material;

a first plastic material is injected into the first part, with the gate in the down position and one of its side walls forms an obstacle to flow of the said first plastic material at the fasteners of the hinge elements on the second part;

the gate is moved such that the second plastic material can flow as far as the first plastic material;

when the first plastic material is still warm, the second plastic material is injected into the second portion of the piece.

This process is useful particularly for sequential multiple material injection moulding of a service capsule containing a base made of a first plastic material and a cap made of a second plastic material, the cap and the base being separated from each other by a hinge comprising at least one film hinge and at least one tensioning element.

In sequential bi-material injection, two different materials (with a different chemical nature and/or due to additives, colours, fillers, etc.) are injected one after the other so that they are combined into a single part without any secondary operation. The device chosen to make these service capsules comprises two injection units, and moulding equipment comprising two main parts; a first mould and a second mould. A mobile element that has a front wall and two side walls slides inside the first mould such that its front wall moves in the moulding cavity. This mobile element, called a “gate”, thus delimits the successive filling zones. In a first position, one of the side walls of this mobile element forms an obstacle to the flow of the first plastic material, and in a second position it allows the second plastic material to pass and thus to come into contact with the first plastic material. The moulding equipment comprises a first mould and a second mould in which the assembled impressions (when the two moulds are locked in contact with each other) form a cavity occupying the volume of the service capsule, with the cap wide open, typically forming an angle of 180° with the base.

The manufacturing cycle comprises:

injection of the first plastic material into the zone of the first part of the capsule, the mobile part being in the closed position (gate closed)

movement of the mobile part until the gate is opened

preferably after a short stabilization of the first plastic material (of the order of one second), injection of the second plastic material into the zone of the second part of the capsule.

The gate must be placed to satisfy a number of criteria; firstly this position determines the boundary between the two materials and the geometric configuration in which the two materials will come into contact. Even if you choose two materials with compatible bonding and/or melting temperatures, it is preferable to aim at a certain interpenetration of the materials to improve bond. Furthermore, as described in FR 2 662 144 and EP 0 826 606, it is recommended that this boundary should be located in an area with low mechanical stresses, particularly in fatigue.

Finally, the mobile part of the equipment (the gate) must be capable of resisting the pressure exerted by the first plastic material when it comes into contact with it. This pressure may be as high as several hundred bars and the gate needs to be guided and held in place to resist the force that tends to move it. In general, an attempt is made to ensure that the side walls of the said gate are surrounded by the walls of the equipment over a given height, at the front wall, so that the gate can perform its functions as an obstacle to the flow of the first plastic material. When the gate is made to slide in a longitudinal cavity, and it is required to prevent the plastic material from flowing in a cavity opening into this longitudinal cavity, the gate is made to slide in the said cavity such that its front wall is on the upstream side of the crossing with the other stream, at a distance equal to at least the thickness of the cavity at this location.

The fatigue resistance of the hinge makes it necessary to avoid putting the junction between the materials exactly in the preferred bending part of the hinge. In the process according to the invention, the applicant moved the junction between the materials towards the side of the fasteners on the cap of the hinge(s) and the tensioning element(s), without it being too visible. Thus, the hinge(s) and the tensioning element(s) are composed of plastic material used for the base of the capsule in their preferred bending and tension areas, and this plastic material is preferably a material with good mechanical properties, particularly with a good resistance to fatigue caused by alternate bending and tension, typically polypropylene.

To facilitate injection conditions and to simplify the shape of the moulding equipment to be made, when the two moulds are locked in contact with each other, the assembled cavities of the first mould and the second mould define the volume of the service capsule with the cap open at 180°. The gate is placed such that it is free to slide in the cavity that will be used for moulding the approximately vertical wall of the cap located close to the base. The mobile part slides vertically in the first mould, in contact with the walls of the said first mould, and opens up in the part of the cavity corresponding to the approximately vertical wall of the cap.

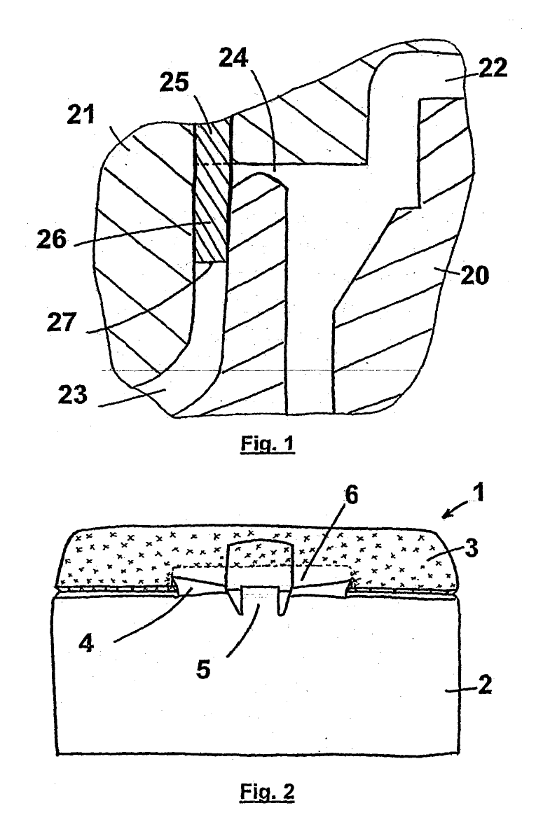

Since the plastic material of the base usually has a melting temperature higher than the plastic material of the cap, it is natural to start by injecting the cap and then the base. FIG. 1 illustrates a first test not based on the invention in which the gate, in the closed position, descends deeper (more than five times the thickness) into the cavity of the cap. The filling pressure is of the order of 300 bars when the cavity is filled, and under the effect of the force applied to the front wall of the gate, the gate could be displaced, move backwards and allow the plastic material of the cap to fill the cavity of the hinge elements, if it is not sufficiently well held in place.

Unfortunately, this natural choice consisting of putting a gate at depth in the part of the vertical wall of the cap, does not produce the required effect, since the boundary between the plastic materials is not at the required location; it allows the plastic material in the base to rise significantly into the cap area and thus destroys the required impression of a clear cut separation between the base and the cap. FIG. 2 illustrates the visual appearance achieved.

To solve this problem, the applicant reversed the sequence of the injections, increased the surface area of the fasteners of the hinge elements on the cap and modified the shape of the gate, which is no longer a simple prism matching the thickness of the wall of the cap, but is now a three-dimensional part with a height and possibly a thickness that are different at the tensioning element of the hinge and at the film hinge. The slope of the oblique wall of the second mould, corresponding to the cavity of the film hinge fastener and the tensioning element on the cap, is significantly increased such that the height of this fastener is at least twice the thickness of the tensioning element.

The gate goes down until its front wall is at the same level as the hinge fastener, flush with the base of the said oblique wall of the second equipment. Therefore, it is not engaged in depth in the cavity of the mould corresponding to the vertical wall of the cap. The sequence of the injections is reversed; the base is injected first with the plastic material that usually has a high melting temperature. This material comes into contact with a side wall of the gate, which under the effect of the thrust can be forced onto the other side wall in contact with the approximately vertical male part of the first equipment that will form the inside of the cap. In this case, although the gate only penetrates slightly into the cavity, it is efficiently supported since the bearing is direct without any cantilever and the air gap, which cannot be greater than the side clearance between the sliding part and the first equipment, is too small for the first plastic material to be able to enter easily.

As soon as the first plastic material has been injected, the gate is raised and the plastic material of the cap is injected. This second plastic material comes into contact with the first plastic material that is still hot at the level of the fasteners of the hinge elements, for which the height according to the invention was significantly increased. Thus, the height at the fastener of the tensioning element is equal to approximately twice the average thickness of this element. The height of the film hinge fastener is exactly the same as the height of the tensioning element fastener, so that the conditions for interpenetration of the plastic materials can be made uniform along all parts of the hinge. The increase in the height of the fastener has little influence on the mechanical behaviour of the film hinge since the thickness of the film hinge was already not uniform with a preferred bending zone, even before the modifications according to the invention were made, but this is not true for the tensioning element which is significantly stiffer at the location of the fastener. However, despite its greater stiffness at the attachment on the cap, this tensioning element continues to play its driving role as the cap rotates. The fact that the fasteners of the hinge elements are higher on the cap provides a larger spatial configuration of the cavity that is more conducive to mix of the two plastic materials, by reducing the shear necessary to obtain a good bond between the said plastic materials.

To improve interpenetration of plastic materials with each other, the front wall of the gate varies in height; when the gate is raised in the open position, the front wall does not rise up inside the upper equipment but remains slightly projecting, which means that there is a smooth transition between the thickness of the relatively thick and approximately vertical wall of the cap and the thickness of the fastener. The fact of leaving the gate projecting slightly at the hinge means that the hinge cannot be deformed; the part of the gate that remains projecting occupies the place of a thick portion of the cap, which if it had been formed with the injected plastic material, would have imposed a significant deformation of the hinge and the base of the capsule during its shrinkage, resulting in an overthickness of the said capsule base which would prevent good closure of the cap on the base.

Finally, the height of the gate at the tensioning element is such that it can close off the cavity of the fastener in the closed position. The only thing necessary is for the gate front wall to drop slightly below the fastener since the thrust of the first plastic material is lateral and the bearing can be made by the other transverse wall, and to bear directly on the core of the first mould used to make the inside of the cap.

The second plastic material may be a polyolefin (typically polyethylene or polypropylene mixed with a filler different from the filler in the polypropylene used to make the base) or an elastomer type thermoplastic material or a material with an elastomeric behaviour or a thermoplastic alloy with an elastomeric behaviour. The fact that the second plastic material may have a melting temperature lower than the first plastic material does not prevent a good bond between the materials, no doubt because two successive injections are made within short intervals.

The process according to the invention describes a sequential bi-material injection. Obviously, it may be transposed to a sequential multiple material injection in which the number of different materials to be injected is more than two, and in which at least one gate is actuated between two injections. Furthermore, the object that can be produced by the invention may be used for other purposes than a service capsule; it is a part comprising two portions made of a different plastic material and free to move with respect to each other, pivoting about a hinge forming the boundary between these two portions.

FIG. 1 illustrates a section showing a detail of a moulding equipment used in prior art to make a service capsule, the section being taken at the film hinge connecting the base (at the right) to the cap (at the left). The conventional technique used in multiple material multiple injection uses a prismatic moving element that forms an obstacle to the flow of the first plastic material that fills the cap.

FIG. 2 illustrates the appearance of the two-colour service capsule obtained with the moulding equipment according to prior art illustrated in FIG. 1.

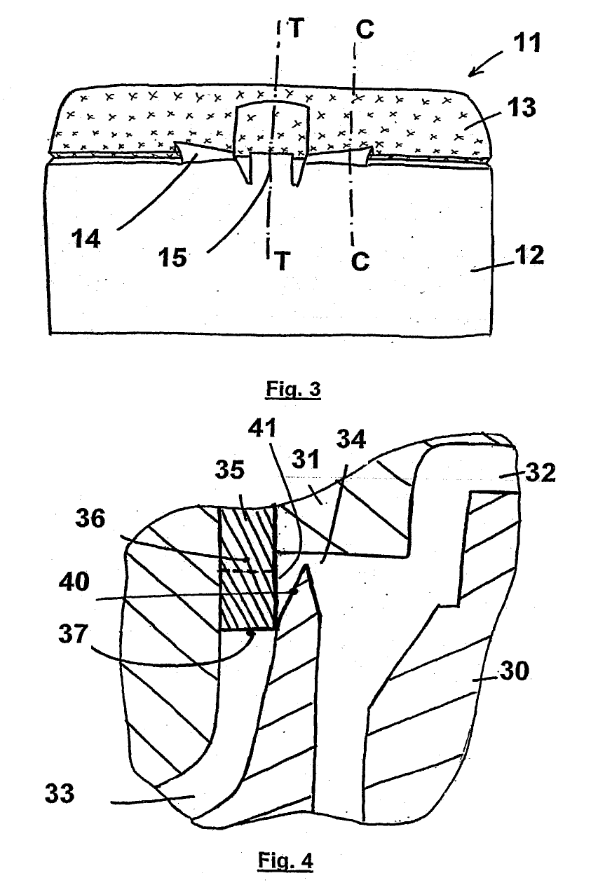

FIG. 3 illustrates the appearance of the two-colour service capsule obtained with the process according to the invention.

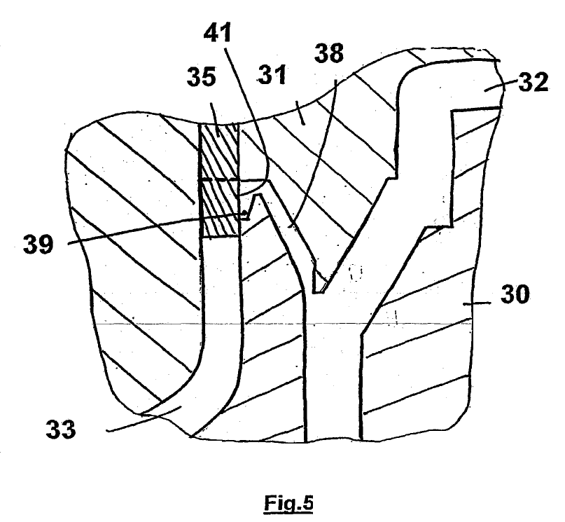

FIG. 4 illustrates a section showing a detail of the moulding equipment according to the invention, used to make a service capsule, the section being taken at the film hinge that connects the base (at the right) to the cap (at the left).

FIG. 5 illustrates a section showing a detail of the moulding equipment according to the invention, used to make a service capsule, the section being taken at the tensioning element that connects the base (at the right) to the cap (at the left).

### EXAMPLES

### Example 1

(FIGS. 1 and 2)

The bi-colour service capsule 1 comprises a cap 3 made of a first plastic material and a base 2 made of a second plastic material, both being connected together by hinge elements consisting of two film hinges 4 and a tensioning element 5.

In the conventional process used to make this two-colour capsule, the moulding equipment comprises two moulds, the first mould 21 and the second mould 20. A mobile part, the gate 25, slides insides the first mould 21, along the continuation of the approximately vertical part of the cavity 23 used for moulding the cap, and the front wall 27 of the gate must descend deeply into the cavity 23, to several millimetres below the cavity 24 corresponding to the hinge, leaving a zone 26 not filled by the plastic material of the cap.

The sequential dual injection process using this moulding equipment and in which the plastic material (transparent polypropylene) of the cap is injected before the opaque polypropylene of the base, results in a hinge area in which the junction between the two plastic materials “rises” significantly above the hinges, leaving a zone 6 that cancels the required impression of a clearly defined separation between the base to the cap.

### Example 2

(FIGS. 3, 4 and 5)

The two-colour service capsule 11 comprises a base 12 made of a first plastic material and a cap 13 made of a second plastic material, both being connected to each other by hinge elements consisting of two film hinges 14 and a tensioning element 15.

In the process according to the invention used to make this two-colour capsule 11, the moulding equipment comprises two moulds, the first mould 31 and the second mould 30. The first step is to inject the base and then the cap.

A mobile part called the gate 35 is free to slide inside the first mould 31, along the continuation of the approximately vertical part of the cavity 33 used to mould the cap, and the front wall 37 of the gate does not descend deeply into the cavity 33. The sections in FIGS. 4 and 5 made along C-C and T-T respectively, show that the gate 35 is thicker at the film hinge than at the tensioning element. The heights of the fasteners of the hinge elements have been increased and defined to be equal to make the bonding conditions of the plastic materials uniform.

The slope of the oblique wall 40 of the second mould 30 corresponding to the cavity of the fastener of the film hinge and the tensioning element 39 to the cap is significantly increased such that the height of this fastener is at least twice the thickness of the tensioning element. The front wall 37 of the gate 35 is flush with the base of the oblique wall 40 of the second mould 30 when the gate is closed. The first plastic material comes into contact with the side wall 41 and despite the high thrust, the gate cannot move more than the play necessary for sliding. In the open position, the gate does not rise completely, and a part 36 remains projecting inside the cavity. It occupies the place of a portion of the cap which, if it had been formed with injected plastic material, would have been very thick and would have imposed a large deformation of the hinge and the base of the capsule due to its shrinkage, causing an overthickness of the said base of the capsule with the consequence of preventing the cap from closing properly on the base.

The capsule obtained gives the impression of a clearly defined separation between the cap and the base.

Nomenclature for the illustrations in FIGS. 1, 2, 3, 4 and 5

1: service capsule;

2: base;

3: cap;

4: hinge;

5: tensioner;

6: inesthetic area;

20,30: second mould;

21,31: first mould;

22,32: cavity corresponding to the base;

23,33: cavity corresponding to the cap;

24,34: cavity corresponding to the film hinge;

25,35: gate;

26: cavity corresponding to the inesthetic area;

36: part of the gate that remains projecting when the gate is in the open position;

37: front wall of the gate;

38: cavity corresponding to the tensioning element;

39: cavity corresponding to the fastener of the tensioning element;

40: oblique wall of the second mould corresponding to the cavity for the fastener of hinge elements (film hinge and tensioning element) to the cap

41: side wall of the gate forming an obstacle to flow of the first plastic material

1. Process for sequential multiple material injection moulding to make a part comprising at least two parts with matching shapes made of different plastic materials, free to move with respect to each other by pivoting about a hinge forming the junction between these two parts, the said hinge possibly being composed of several elements stressed in bending or tension, characterized in that:
a moulding equipment comprising a first mould (31) and a second mould (32) is used, in which the impressions are such that once the first and second moulds are assembled and locked together, they define the cavity (32, 34 and 33) of the open part, the opening angle between the mobile parts being large, typically close to 180°, the first mould (31) comprising a housing in which a mobile element called a gate (35) is free to slide, with two side walls (41, 42) and a front wall (37), that blocks the flow of the first plastic material when it is in the closed position, the said gate having two side walls (41, 42) and a front wall (37), which moves in the cavity (33) that will contain the second plastic material;
a first plastic material is injected into the first part (32 and 34), with the gate in the down position and its side wall (41) forms an obstacle to flow of the said first plastic material at the fasteners of the hinge elements on the second part;
the gate (35) is moved such that the second plastic material can flow as far as the first plastic material;
when the first plastic material is still warm, the second plastic material is injected into the second portion of the piece.

2. Process according to claim 1, in which the part is a service capsule that will be fixed on the head of a flexible tube, a bottle or a tottle, the first portion of the piece being its base, the second portion being the cap, the hinge connecting the said base to the said cap comprising at least one film hinge and at least one tensioning element.

3. Process according to claim 2, in which the attachment of the tensioning element onto the cap is at a height equal to at least twice the average thickness of the said tensioning element.

4. Process according to claim 2 or 3, in which the gate in the open position remains, in the vicinity of the film hinge cavity, projecting in the cavity of the second part.

5. Process according to any one of claims 1 to 4, in which the first plastic material forms part of the polypropylene group.

6. Process according to any one of claims 1 to 5, in which the second plastic material forms part of the group consisting of polyolefins and thermoplastic alloys with elastomeric behaviour.
